(19) United States
(12) Patent Application Publication
(10) Pub. No.: US 2023/0196221 A1
(43) Pub. Date: Jun. 22, 2023

(54) CITY MANAGEMENT SUPPORT APPARATUS, CITY MANAGEMENT SUPPORT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Masahiro KUWAHARA, Kasukabe-shi (JP); Yukihisa FUJITA, Tokyo-to (JP); Hideo HASEGAWA, Tokyo-to (JP)

(73) Assignee: TOYOTA JIDOSHA KABUSHIKI KAISHA, Toyota-shi (JP)

(21) Appl. No.: 17/989,945

(22) Filed: Nov. 18, 2022

(30) Foreign Application Priority Data
Dec. 20, 2021 (JP) 2021205902

(51) Int. Cl. G06Q 10/06; G06Q 50/10

(52) U.S. Cl. CPC G06Q 10/0631; G06Q 50/10

(57) ABSTRACT

The city management support apparatus according to the present disclosure is an apparatus that supports management of a city in which a plurality of services sharing a finite resource are simultaneously provided. The city management support apparatus acquires information on a provision status of the resource, and predicts a service achievement level of each of the plurality of services in future by a predetermined time based on the provision status of the resource. Then, the city management support apparatus calculates priority order of provision of the resource among the plurality of services based on the service content and the service achievement level of each of the plurality of services, and outputs the priority order among the plurality of services.

### CROSS-REFERENCE TO RELATED APPLICATION

The present application claims priority under 35 U.S.C. § 119 to Japanese Patent Application No. 2021-205902, filed Dec. 20, 2021, the contents of which application are incorporated herein by reference in their entirety.

### BACKGROUND

### Field

The present disclosure relates to a city management support apparatus, a city management support method, and a non-transitory computer-readable storage medium storing a city management support program suitable for use in management of a city in which a plurality of services sharing a finite resource are simultaneously provided.

### Background Art

Today, “cities” where services are centrally managed through smart technology are being studied and planned in many locations. The term “city” as used herein means a physical space where people live by being provided with various services, and includes not only a large-scale space such as a so-called smart city but also a medium-scale space such as an underground mall and a small-scale space such as a large-scale building. In such cities, many of the resources provided therein are finite, and in many cases, the finite resources are shared by a plurality of services. Continuous development of cities requires efficient and appropriate management by city managers in terms of both resources and services.

However, it is difficult to say that research has been sufficiently advanced so far on the management of a city where a plurality of services sharing finite resources are simultaneously provided. For example, WO2019/189152 discloses a technique in which a traffic monitoring apparatus calculates, for each of a plurality of continuous congested routes, a priority for taking a measure for eliminating congestion based on at least a vehicle traveling direction in each of the plurality of continuous congested route. However, this technique does not take into consideration the fact that there is a possibility that the resources of a city are finite and may become unavailable.

In addition to WO2019/189152, JP2015-187498A, JPH11-0353358A, and WO2013/084268 can be exemplified as documents showing the technical level of the technical field related to the present disclosure.

### SUMMARY

The present disclosure has been made in view of the above-described problem, and an object thereof is to provide a technique useful for management of a city in which a plurality of services sharing a finite resource are simultaneously provided.

In order to achieve the above object, the present disclosure provides a city management support apparatus. The city management support apparatus of the present disclosure is an apparatus that supports management of a city in which a plurality of services sharing a finite resource are simultaneously provided. The city management support apparatus according to the present disclosure includes at least one memory storing at least one program and at least one processor executing the at least one program. The at least one program is configured to cause the at least one processor to execute: acquiring information on a provision status of the resource; and predicting a service achievement level of each of the plurality of services in future by a predetermined time based on the provision status of the resource. Further, the at least one program is configured to cause the at least one processor to execute: calculating priority order of providing the resource among the plurality of services based on a service content and the service achievement level of each of the plurality of services; and outputting the priority order among the plurality of services.

In addition, in order to achieve the above object, the present disclosure provides a city management support method. The city management support method according to the present disclosure is a method for supporting, using a computer, management of a city in which a plurality of services sharing a finite resource are simultaneously provided. The city management support method according to the present disclosure comprises: inputting information on a provision status of the resource into the computer; and predicting, by the computer, a service achievement level of each of the plurality of services in future by a predetermined time based on the provision status of the resource. Furthermore, the city management support method according to the present disclosure comprises: calculating, by the computer, priority order of providing the resource among the plurality of services based on a service content and the service achievement level of each of the plurality of services; and outputting the priority order among the plurality of services from the computer.

Further, in order to achieve the above object, the present disclosure provides a city management support program. The city management support program according to the present disclosure is a program for supporting, using a computer, management of a city in which a plurality of services sharing a finite resource are simultaneously provided. The city management support program according to the present disclosure is configured to cause a computer to execute: acquiring information on a provision status of the resource; and predicting a service achievement level of each of the plurality of services in future by a predetermined time based on the provision status of the resource. Furthermore, the city management support program according to the present disclosure is configured to cause the computer to execute: calculating priority order of providing the resource among the plurality of services based on a service content and the service achievement level of each of the plurality of services; and outputting the priority order among the plurality of services. The city management support program according to the present disclosure is stored in a non-transitory computer-readable storage medium.

According to the above-described technique of the present disclosure, the priority order among the plurality of services simultaneously provided in a city is presented to the city manager. From the output, the city manager can recognize which service should be preferentially provided with the resource and which service should be requested to refrain from using the resource.

In the above-described technique of the present disclosure, the priority order among the plurality of services may be output in a form associated with the provision status of the resource. According to this, the city manager can grasp the relation between the provision status of the resource and the priority order of the provision of the resource among the plurality of services.

In addition, in the above-described technique of the present disclosure, the priority order among the plurality of services may be output in a form associated with the provision status of the resource together with the service achievement level for each of the plurality of services. According to this, the city manager can grasp the relation among the provision status of the resource, the service achievement level of each of the plurality of services, and the priority order of the provision of the resource among the services.

In addition, in the above-described technique of the present disclosure, the service achievement level of each of the plurality of services may be predicted in response to occurrence of an abnormality in the provision status of the resource. According to this, the occurrence of an abnormality in the provision status of the resource is set as a condition for prediction, so that it is possible to reduce the load on the processor and to suppress the use of power associated with calculation.

Furthermore, in the above-described technique of the present disclosure, the use limit of the resource may be calculated for each of the plurality of services based on the service content and the service achievement level for each of the plurality of services, and the use limit for each of the plurality of services may be output. According to this, the city manager can request cooperation from each service provider based on the use limit of resources calculated for each service.

As described above, the technique of the present disclosure is useful in the management of a city in which a plurality of services sharing a finite resource are simultaneously provided.

### BRIEF DESCRIPTION OF THE DRAWINGS

FIG. 1 is a diagram showing an overview of a city according to an embodiment of the present disclosure.

FIG. 2 is a block diagram illustrating a configuration of a city management support apparatus according to the embodiment of the present disclosure.

FIG. 3 is a schematic city diagram of a city according to an embodiment of the present disclosure.

FIG. 4 is a diagram for explaining examples of services sharing roads provided in the city shown in FIG. 3.

FIG. 5 is a diagram showing an example of a screen of the city management support apparatus when the services provided in the city is the services shown in FIG. 4.

FIG. 6 is a diagram showing another example of the screen of the city management support apparatus when the services provided in the city is the services shown in FIG. 4.

FIG. 7 is a diagram for explaining examples of services sharing power supply stations provided in the city shown in FIG. 3.

FIG. 8 is a diagram showing an example of the screen of the city management support apparatus when the services provided in the city is the services shown in FIG. 7.

FIG. 9 is a diagram for explaining examples of services sharing storage yards provided in the city shown in FIG. 3.

FIG. 10 is a diagram showing an example of the screen of the city management support apparatus when the services provided in the city is the services shown in FIG. 9.

### DETAILED DESCRIPTION

Hereinafter, an embodiment of a city management support apparatus, a city management support method, and a city management support program according to the present disclosure will be described with reference to the drawings. However, in the embodiment described below, when a numerical value such as the number, quantity, amount, or range of each element is mentioned, the present invention is not limited to the mentioned numerical value unless otherwise specified or unless it is clearly specified to the numerical value in principle. In addition, structures and the like described in the following embodiment are not necessarily essential to the present invention except for a case where the structures and the like are clearly specified in particular or a case where the structures and the like are obviously specified in principle.

### 1. City Overview

In the present disclosure, a city refers to a physical space in which people live by receiving the provision of various services. There is no limitation on the size of a city in the present disclosure. A smart city is an example of a large city, an underground mall is an example of a medium-sized city, and a large building is an example of a small city. A virtual space of the Internet that is not a physical space is not included in a city in the present disclosure.

In a city, various services are provided to users. Services are provided using resources of the city. The resources are those used to provide services in a city and include, for example, roads, power supply stations, storage yards, networks, electricity, water, and the like. If a logistics service uses elevators in the building, the elevators are also included in the resources. However, the resources in the present disclosure are finite, and those that are infinite or finite but whose limit is sufficiently high compared to the amount of resources used by the service are not included in the resources in the present disclosure. In a city in the present disclosure, finite resources are shared by a plurality of services.

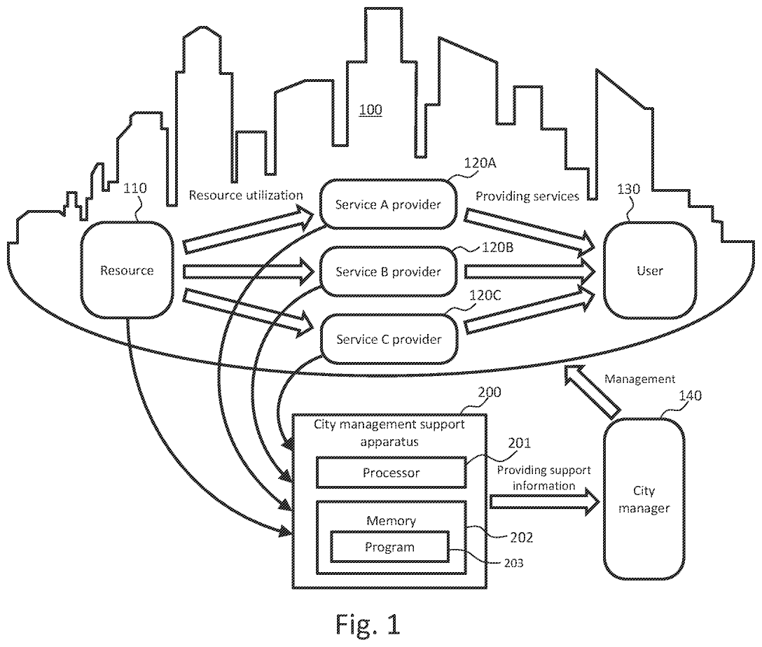

FIG. 1 shows an overview of a city 100 according to an embodiment of the present disclosure. In the city 100 according to the present embodiment, services A, B, and C sharing a finite resource 110 are simultaneously provided to the user 130 from providers 120A, 120B, and 120C of the services A, B, and C. That a plurality of services using the finite resource 110 are simultaneously provided means that one user 130 simultaneously uses the plurality of services, and also means that the plurality of services using the finite resource 110 are not mutually exclusive. That is, any one of the services A, B, and C provided in the city 100 does not exclusively use the resource 110, and any two of the services do not use the resource 110 in an oligopolistic manner.

The provision status of each of the services A, B, and C for the user 130 is affected by the provision status of the resource 110 in the city 100, and in particular, by an abnormality in the provision status. Which service is affected to what degree depends on the content of the abnormality in the provision status of the resource 110. For example, only some services may be affected, or all services may be affected. Depending on the content of the abnormality in the provision status of the resource 110, the service provision method may be changed from the normal provision method to the alternative provision method to suppress the deterioration of the service. However, since the resource 110 is shared, for example, in order to maintain one service, another service may have to be deteriorated. How to suppress the deterioration of the service in the city 100 as a whole when an abnormality occurs in the provision status of the resource 110 is an important issue in management of the city 100.

In the city 100 according to the present embodiment, the provision statuses of the services A, B, and C are collectively managed by the city manager 140 together with the provision status of the resource 110. The city manager 140 monitors the provision status of the resource 110, and has the authority and responsibility to quickly recover if an abnormality occurs in the provision status of the resource 110. However, depending on the type of the resource 110, the city manager 140 may entrust regular maintenance or restoration from an abnormality to another company, or the provision itself of the resource 110 may be performed by another company.

The city manager 140 is basically a different entity from the service providers 120A, 120B, and 120C. Except for the case where the city manager 140 provides the service by itself, the city manager 140 basically cannot change the method of providing the service. When an abnormality occurs in the provision status of the resource 110, the city manager 140 notifies the service providers 120A, 120B, and 120C of the situation, and advises an alternative method of the service provision method as necessary.

In the city 100 according to the present embodiment, the city manager 140 is required to efficiently and appropriately manage both the resource 110 and the services A, B, and C due to the continuous development of the city 100. A city management support apparatus 200 according to the embodiment of the present disclosure is an apparatus for supporting efficient and appropriate management of the city 100 by the city manager 140. The city management support apparatus 200 does not manage the city 100 by itself, but supports city management by the city manager 140 by providing support information. The support information provided by the city management support apparatus 200 to the city manager 140 includes information about the current provision status of the resource 110, predictive information about the future status of each service, advice to the city manager 140 when service deterioration is predicted, and the like.

The city management support apparatus 200 is a computer comprising at least one memory 202 storing at least one program 203 and at least one processor 201 executing the at least one program 203. When the at least one program 203 stored in the at least one memory 202 is executed by the at least one processor 201, various functions for supporting the city manager 140 are realized. However, the city management support apparatus 200 may be constituted by a single computer or may be constituted by a plurality of computers connected via a network. The next section describes the city management support apparatus 200 in more detail.

### 2. Configuration of City Management Support Apparatus

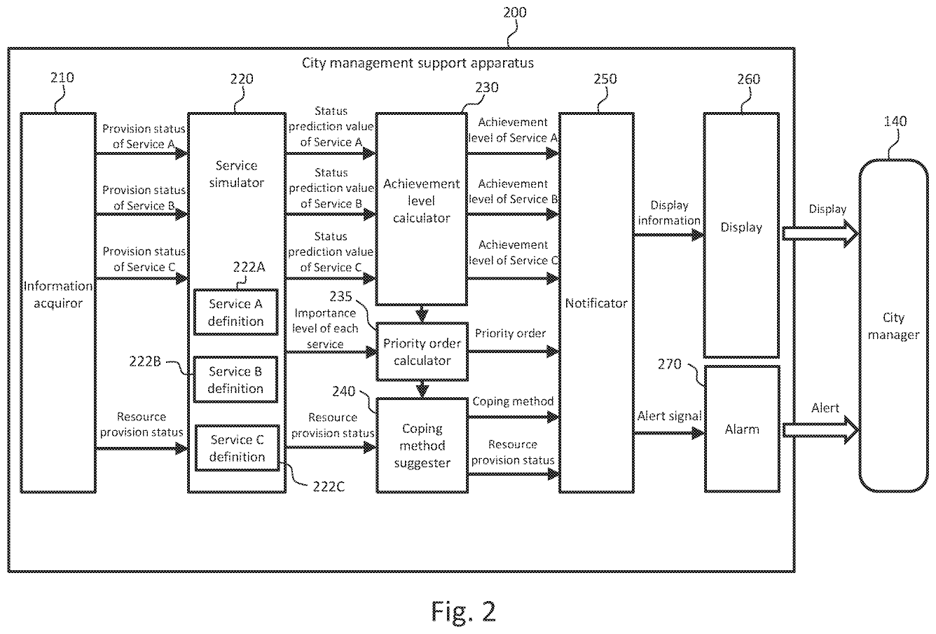

FIG. 2 is a block diagram showing the configuration of the city management support apparatus 200. The city management support apparatus 200 includes an information acquiror 210, a service simulator 220, an achievement level calculator 230, a priority order calculator 235, a coping method suggester 240, a notificator (notification unit) 250, a display 260, and an alarm 270. These elements constituting the city management support apparatus 200 are functions of the city management support apparatus 200 implemented when the at least one program 203 stored in the at least one memory 202, specifically, the city management support program is executed by the at least one processor 201.

The information acquiror 210 acquires information necessary for management of the city 100 from the city 100. The information acquired by the information acquiror 210 includes information about the provision status of the resource 110 in the city 100. The information on the provision status of the resource 110 is acquired from, for example, information detected by various sensors deployed in the city 100, provided information from the service providers 120A, 120B, and 120C, or provided information from the user 130 including information on the SNS. The information on the provision status of the resource 110 acquired by the information acquiror 210 is input to the service simulator 220.

The information acquired by the information acquiror 210 includes information on the provision status of each of the services A, B, and C. The information on the provision status of the service A is acquired from the service provider 120A. The information on the provision status of the service B is acquired from the service provider 120B. The information on the provision status of the service C is acquired from the service provider 120C. However, for example, in a case where two services are provided by the same provider, information on the provision status of the two services is acquired from that provider. It is also possible to acquire the information on the provision status of the service from information provided from the user 130 including information on the SNS. The information on the provision status of each of the services A, B, and C acquired by the information acquiror 210 is input to the service simulator 220.

The service simulator 220 is a simulator that predicts the state of a service in the future by a predetermined time using a prediction model. Inputs to the service simulator 220 are information on the current provision status of each of the services A, B, and C and information on the current provision status of the resource 110. The service simulator 220 predicts the future status of each of the services A, B, and C by a predetermined time using a prediction model based on the input information. The prediction time is, for example, 10 minutes, 1 hour, 2 hours, or the like, and is determined according to the content of the service.

In the prediction model used by the service simulator 220, parameters relating to the relationship between the resource 110 and the service are created in advance in accordance with the specifications of the city 100. For example, in a case where the service provided in the city 100 is a traffic service or a logistics service, parameters such as the states of buildings or roads, the locations and conditions of moving bodies, a resident model, and a usage method of the moving bodies by the service are created in advance. The resident model is a model of residents in the city 100. Residents affect the relationship between resource 110 and services, such as sometimes becoming an obstacle to moving bodies and sometimes using roads. In the resident model, according to the content of the service, the movement of each resident may be simulated or the movement as a group may be simulated.

In the prediction model used by the service simulator 220, a service definition is set for each service. For example, in a case where the service provided in the city 100 is a traffic service, a route, a timetable, a predicted number of people getting on and off, an alternative method of a service provision method when an abnormality occurs in the provision status of the resource 110, and the like are set as the service definition. In a case where the service provided in the city 100 is a logistics service, the predicted number of receipts, the predicted destination, an alternative method of a service provision method when an abnormality occurs in the provision status of the resource 110, and the like are set as the service definition. In addition, an importance level determined from the content of the service is set for each service as one of service definitions. In the service simulators 220, the definition of the service A is set in the definition setting section 222A, the definition of the service B is set in the definition setting section 222B, and the definition of the service C is set in the definition setting section 222C. The service definitions set in the definition setting sections 222A, 222B, and 222C can be updated.

The prediction of the state of the service in the future by the predetermined time by the service simulator 220 may be continuously executed, or may be executed on condition that an abnormality occurs in the provision status of the resource 110. An abnormality in the provision status of the resource 110 is an abnormality that affects a service achievement level to be described later, and is defined in advance for each resource and each service. By setting the abnormality in the provision status of the resource 110 as the execution condition of the prediction, it is possible to reduce the load on the processor 201 and to suppress the use of power associated with the calculation.

The status prediction values of the services A, B, and C are output from the service simulator 220. That is, each of the prediction results of the states of the services A, B, and C in the future by the predetermined time is represented by one numerical value. The status prediction values of the services A, B, and C are input to the achievement level calculator 230.

The achievement level calculator 230 calculates a service achievement level for each of the services A, B, and C based on the status prediction values of the services A, B, and C input from the service simulator 220. The service achievement level is a numerical value indicating an impact of service deterioration on the user 130, and is defined as a numerical value indicating a degree of deviation from a predefined level, such as a service level agreement (SLA). Details of a method of calculating the service achievement level for each service will be described later. The service achievement level may be a single value for each service, or may include an achievement level (first value) from the viewpoint of the service providers 120A, 120B, and 120C and an achievement level (second value) from the viewpoint of the users 130. The achievement levels of the services A, B, and C calculated by the achievement level calculator 230 are input to the priority order calculator 235 and the notificator 250.

The priority order calculator 235 receives the achievement levels of the services A, B, and C input from the achievement level calculator 230 and the importance levels of the services A, B, and C input from the service simulator 220. The priority order calculator 235 calculates the priority order of the provision of the resource 110 between the services A, B, and C based on the importance level and the service achievement level of each service. Details of a method of calculating the priority order will be described later. The priority order of the provision of the resource 110 between the services A, B, and C calculated by the priority order calculator 235 is input to the coping method suggester 240 and the notificator 250.

The coping method suggester 240 receives the priority order of the provision of the resource 110 between the services A, B, and C input from the priority order calculator 235 and the information on the provision status of the resource 110 input from the service simulator 220. The coping method suggester 240 suggests coping methods for an abnormality in the provision status of the resource 110 in descending order of priority. The coping method suggested by the coping method suggester 240 is a service provision method capable of reducing the influence of an abnormality in the provision status of the resource 110. The coping method suggester 240 selects an alternative provision method suitable for suggesting as a coping method for an abnormality in the provision status of the resource 110 from one or a plurality of alternative provision methods defined in advance in the definition setting sections 222A, 222B, and 222C. The alternative provision method selected by the coping method suggester 240 is input to the notificator 250.

The notificator 250 receives the achievement levels of the services A, B, and C input from the achievement level calculator 230 and the priority order of the provision of the resource 110 between the services A, B, and C input from the priority order calculator 235. Further, the notificator 250 receives the information on the provision status of the resource 110 input from the coping method suggester 240 and the coping method for an abnormality in the provision status of the resource 110 input from the coping method suggester 240.

The notificator 250 is connected to a display 260. The notificator 250 generates display information to be displayed on the display 260 based on the information received from the achievement level calculator 230, the information received from the priority order calculator 235, and the information received from the coping method suggester 240. In particular, when an abnormality in the provision status of the resource 110 is detected, the notificator 250 generates display information that associates the priority order between the services A, B, and C with the provision status of the resource 110 and the service achievement level for each service. In addition, when a coping method for an abnormality in the provision status of the resource 110 is suggested for a service having a high priority, the notificator 250 generates display information that associates the suggested coping method with the provision status of the resource 110. The notificator 250 inputs the generated display information to the display 260.

The notificator 250 is connected to the alarm 270. When an abnormality occurs in the provision status of the resource 110, the notificator 250 inputs an alert signal to the alarm 270.

The display 260 converts the display information input from the notificator 250 into an image and displays the image. The image displayed on the display 260 includes an image indicating the achievement level of each of the services A, B, and C in the future by a predetermined time and an image indicating the current provision status of the resource 110. Further, when an abnormality occurs in the provision status of the resource 110, an image indicating the priority order of the provision of the resource 110 between the services A, B, and C and an image indicating the coping method for the abnormality in the provision status of the resource 110 with respect to a service having a high priority are displayed on the display 260.

Based on the image displayed on the display 260, the city manager 140 can recognize which service should be preferentially provided with the resource 110 and which service should be requested to refrain from using the resource 110. In addition, the city manager 140 can visually grasp the relationship between the provision status of the resource 110, the service achievement level for each service, and the priority order of the provision of the resource 110 between the services A, B, and C. In addition, the city manager 140 can know a coping method for an abnormality in the provision status of the resource 110 with respect to a service having a high priority in providing the resource 110.

The alarm 270 receives the alert signal input from the notificator 250 and outputs an alert. The city manager 140 can notice, by an alert, an abnormality occurring in the provision status of the resource 110 without constantly monitoring the abnormality in the provision status of the resource 110.

### 3. Specific Example of City Management Support Method by City Management Support Apparatus

### 3-1. Premise

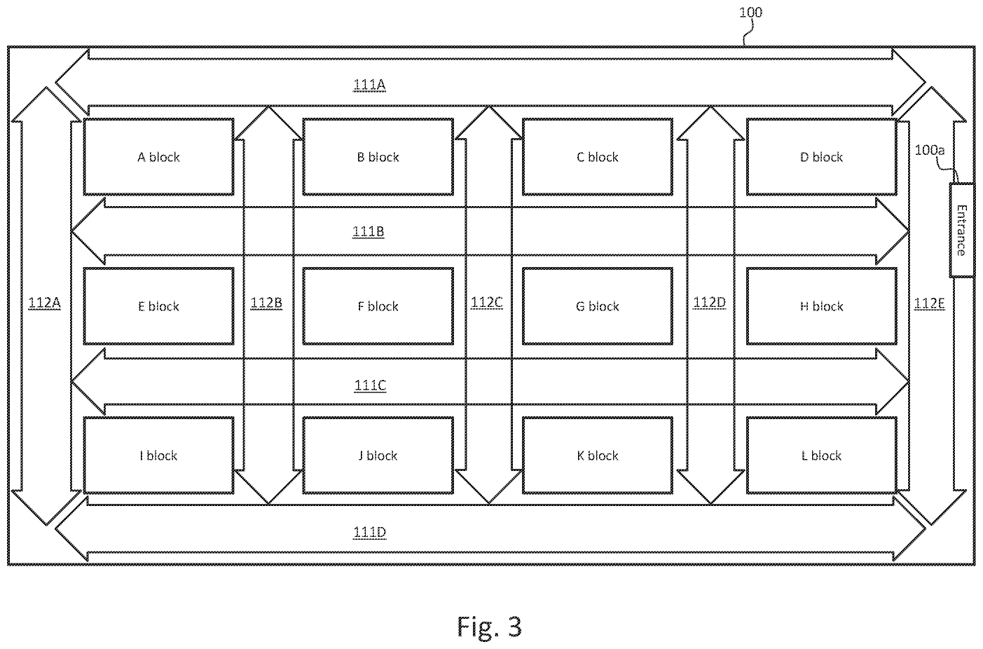

Several concrete examples of the city management support method using the city management support apparatus 200 will be described below. As a premise for explaining the specific example, it is assumed that the city 100 is configured as shown in a schematic city map of FIG. 3. As shown in the city map, a city 100 is a closed space having one entrance 100a, and a road is formed inside the city. The roads include four east-west roads 111A, 111B, 111C, and 111D running east-west, and five north-south roads 112A, 112B, 112C, 112D, and 112E running north-south. By these roads, the inside of the city 100 is divided into 12 blocks from block A to block L. As will be described in a later example, roads are a finite resource 110 for providing various services in city 100.

### 3-2. First Specific Example

### 3-2-1. Overview of Service

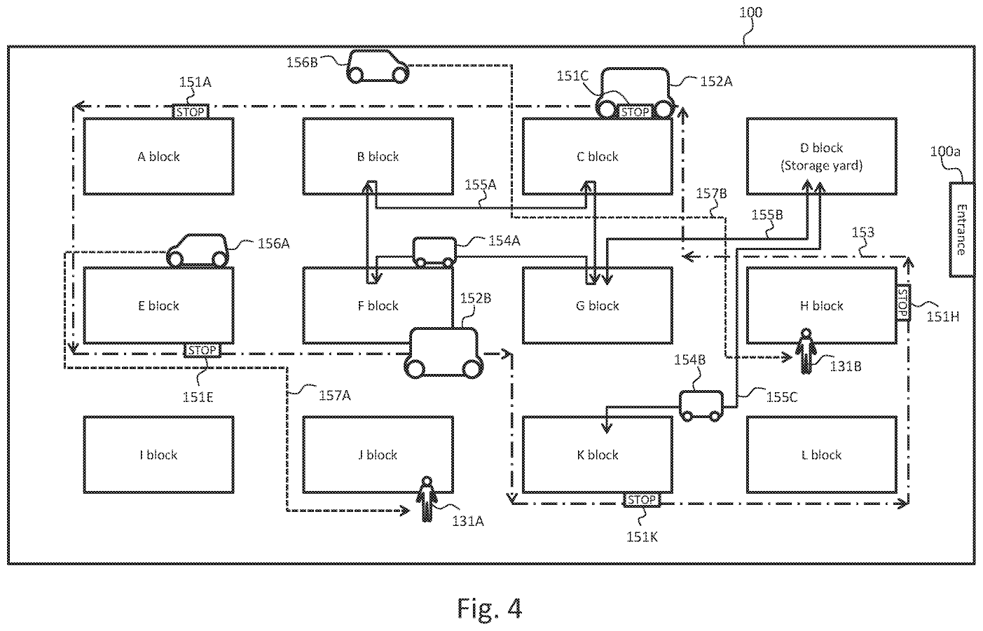

As the first specific example, an example in which the service provided in the city 100 is a service sharing roads will be described. FIG. 4 is a diagram for explaining the first specific example.

In the first specific example, the resource 110 shared among services is roads. Four east-west roads 111A, 111B, 111C, and 111D and five south-north roads 112A, 112B, 112C, 112D, and 112E shown in FIG. 3 are the resource 110 shared among the services in the first specific example.

In the first specific example, the services sharing roads that are the resource 110 are three services of regular route bus service, logistics service, and ride sharing service. When applied to the examples shown in FIGS. 1 and 2, the regular route bus service is the service A, the logistics service is the service B, and the ride sharing service is the service C. The roads are a finite resource having restrictions on a line width, the number of lanes, and the like, and is shared by vehicles of respective services passing therethrough.

The regular route bus service is a kind of traffic service that uses route buses 152A and 152B to carry passengers. The provider 120A of the regular route bus service is, for example, a bus company. The user 130 of the regular route bus service is a passenger who travels on the route buses 152A and 152B. The route buses 152A and 152B are electrically driven self-driving buses equipped with rechargeable batteries. The route buses 152A and 152B travel along a predetermined service target route 153, and are operated so as to stop at bus stops 151A, 151E, 151K, 151H, and 151C in order according to a predetermined timetable. The route buses 152A and 152B are charged at a power supply station (not shown) at a predetermined timing.

The logistics service is a service for delivering packages between bases or buildings using delivery robots 154A and 154B. The provider 120B of the logistics service is, for example, a transportation company. The user 130 of the logistics service is a sender and a receiver of packages. The delivery robots 154A and 154B autonomously travel between bases such as between buildings, between floors of buildings, and between a storage yard and a building to deliver packages. The packages delivered by the delivery robots 154A and 154B include packages generated inside the city 100 and packages brought in from outside the city 100. The packages transported to the city 100 from the outside are carried into the storage yard provided in the D block closest to the entrance 100a, and are delivered from the storage yard to various places (including a relay station for packages) in the city 100. The packages transported from the city 100 to the outside are collected in the storage yard, and carried out from the storage yard to the outside through the entrance 100a.

The operation of the delivery robots 154A and 154B is dynamically scheduled in accordance with the delivery amount. In the example shown in FIG. 4, the delivery robot 154A delivers packages through a delivery route 155A that circulates through the B block, the C block, the G block, and the F block. Further, the delivery robot 154B delivers packages through a delivery route 155B between the storage yard provided in the D block and the G block and a delivery route 155C between the storage yard provided in the D block and the K block.

Although the delivery robots 154A and 154B shown in FIG. 4 are of one type, actually, a plurality of types of robots are prepared in accordance with the types of delivery sections and the types of packages to be delivered. Further, a larger number of robots are prepared in accordance with the number of delivery sections and the amount of packages to be delivered. The size, loading capacity, driving time, and the like of the robot vary depending on the type, but all robots are driven by electricity. In addition, a place where the robot moves differs depending on the size. The delivery robots 154A and 154B are robots that move on roads as a shared resource, but there are also robots that move on sidewalks, in-facility passages, and the like.

The ride sharing service is a service in which residents of the city 100 allocate private vehicles 156A and 156B in operation in response to requests from other residents. The private vehicles 156A and 156B may be owned by residents or shared by a group composed of specific members. The provider 120C of the ride sharing service is, for example, a platformer that operates a matching platform. The user 130 of the ride sharing service is a passenger who requests vehicle allocation. A resident who wants to participate in the ride sharing using his/her private vehicle registers as a driver in the matching platform provided by the service provider. When there is a demand for vehicle allocation, the registered driver is presented with a pick-up location and a route. On the other hand, a resident who wants to use the ride sharing service, that is, a passenger who requests vehicle allocation specifies a pick-up location and time via an application of a terminal owned by the resident when the resident wants to move.

In the example shown in FIG. 4, the matching platform assigns the driver of the private vehicle 156A in response to the vehicle allocation request from the user 131A, and presents the pick-up/drop-off locations for the user 131A and the route 157A to the driver of the private vehicle 156A. In addition, the matching platform assigns the driver of the private vehicle 156B in response to the vehicle allocation request from the user 131B, and presents the pick-up/drop-off locations for the user 131B and the route 157B to the driver of the private vehicle 156B.

### 3-2-2. Example of Screen of City Management Support Apparatus

If the three services described above are provided in the city 100, the city management support apparatus 200 provides support information on those services to the city manager 140. As described above, the means for providing information to the city manager 140 by the city management support apparatus 200 is the display 260 and the alarm 270.

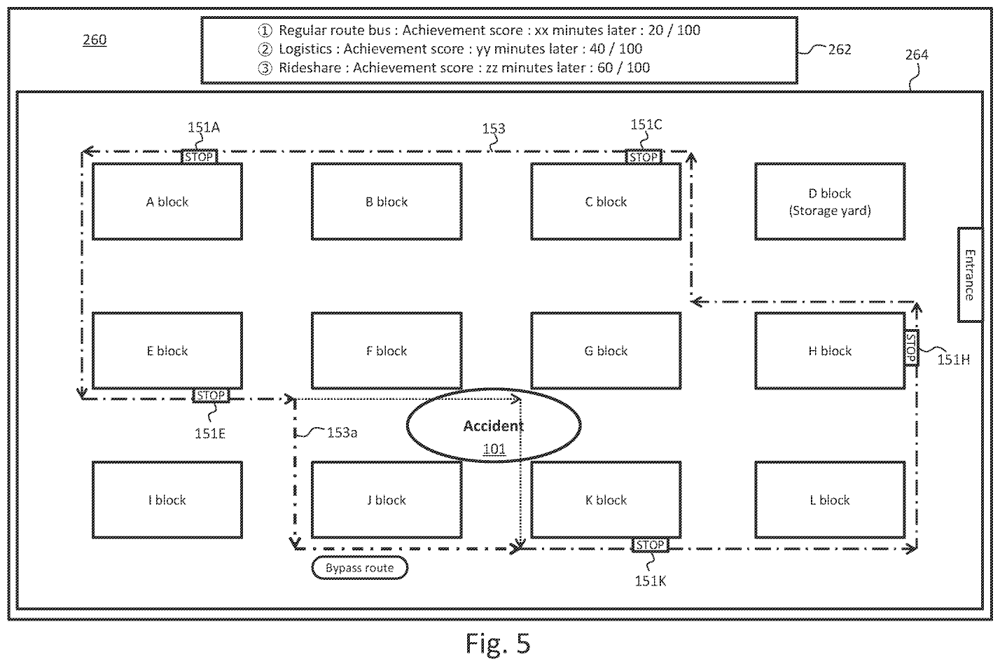

FIG. 5 shows an example of a screen of the display 260 of the city management support apparatus 200 according to the first specific example. The display 260 displays an achievement level window 262 for displaying the service achievement level of each service and a resource provision status window 264 for displaying the provision status of the resource 110 in the city 100. In the achievement level window 262, the service achievement level is displayed in text for each service. On the other hand, in the resource provision status window 264, a city map is displayed so that the provision status of the resource 110 in the city 100 can be recognized at a glance.

First, the achievement level window 262 will be described. When all services provided in the city 100 are favorable, that is, when there is no abnormality in the provision status of the resource 110, nothing is displayed in the achievement level window 262. However, in a case where an abnormality occurs in the provision situation of the resource 110, In the achievement level window 262, the service achievement level after a predetermined time is displayed as a score (achievement score) with respect to each service of regular route bus, logistics, and ride sharing. The achievement score is calculated by a point deduction scoring method with 100 points being the highest score. Hereinafter, a method of calculating the degree of achievement for each service will be described.

A method of calculating the service achievement level of the regular route bus service by the city management support apparatus 200 will be described. The information on the provision status of the regular route bus service input to the service simulator 220 of the city management support apparatus 200 includes, for example, information on the status of each route bus, a timetable, and a service target route. The information on the state of the route bus includes, for example, a location, a speed, the number of passengers, whether the route bus is in service, and a remaining battery power. These pieces of information are input to the service simulator 220. The service simulator 220 predicts the estimated arrival time at the next bus stop for each route bus based on the input information. Then, the estimated arrival time at the next bus stop predicted for each route bus is output as a status prediction value of the regular route bus service.

The achievement level calculator 230 calculates the service achievement level based on the estimated arrival time at the next bus stop predicted by the service simulator 220. The following Equation 1 is used to calculate the service achievement level of the regular route bus service. However, the calculated value on the right side of Equation 1 is rounded off to be an integer, and the service achievement level is represented by an integer from 0 to 100. When the calculated value on the right side of Expression 1 is a negative value, the service achievement level is set to 0.

Service achievement level=100−(absolute value of the difference between the estimated arrival time and the scheduled time on the timetable(minute unit))*100/60 Equation 1

The achievement level calculator 230 calculates the service achievement level for each route bus according to Equation 1 above. In the example shown in FIG. 4, the service achievement level of the route bus 152A and the service achievement level of the route bus 152B are respectively calculated. The achievement level calculator 230 outputs the lower one of the service achievement level of the route bus 152A and the service achievement level of the route bus 152B as the service achievement level of the route bus service. Alternatively, the average value of the service achievement level of the route bus 152A and the service achievement level of the route bus 152B is output as the service achievement level of the regular route bus service.

Next, a calculation method of the service achievement level of the logistics service by the city management support apparatus 200 will be described. The information on the provision status of the logistics service input to the service simulator 220 of the city management support apparatus 200 includes, for example, information on the state of each delivery robot, daily delivery plan, and a remaining delivery packages. The information on the state of the delivery robot includes, for example, a location, a speed, the number of packages, whether the delivery robot is in service, a battery remaining power, a delivery destination, and a delivery source. These pieces of information are input to the service simulator 220. The service simulator 220 predicts the deviation from the daily delivery plan, I. e., the average delay in delivery, based on the entered information. Then, the predicted average delay in delivery is output as a status prediction value of the logistics service.

The achievement level calculator 230 calculates the service achievement level based on the average delay in delivery predicted by the service simulator 220. The following Equation 2 is used to calculate the service achievement level of the logistics service. However, the calculated value on the right side of Equation 2 is rounded off to be an integer, and the service achievement level is represented by an integer from 0 to 100. When the calculated value on the right side of Expression 2 is a negative value, the service achievement level is set to 0.

Service achievement level=100−(average delay in delivery(minute unit))*100/60 Expression 2

Next, a method of calculating the service achievement level of the ride sharing service by the city management support apparatus 200 will be described. The information on the provision status of the ride sharing service input to the service simulator 220 of the city management support device 200 includes, for example, information on the state of each vehicle available for sharing and information on demand. The information on the state of the vehicle includes, for example, a location, a speed, the number of passengers, whether the vehicle is in service, and a remaining battery power. The information on demand includes, for example, time, start and end points, and the number of people. These pieces of information are input to the service simulator 220. The service simulator 220 predicts an average waiting time before boarding (for example, an average value in the past one hour) based on the input information. Then, the predicted average waiting time before boarding is output as a status prediction value of the ride sharing service.

The achievement level calculator 230 calculates the service achievement level based on the average waiting time before boarding predicted by the service simulator 220. The following Equation 3 is used to calculate the service achievement level of the ride sharing service. The standard waiting time in Formula 3 is a standard SLA of the waiting time before boarding, and can be set to 10 minutes, for example. However, the calculated value on the right side of Expression 3 is rounded off to be an integer, and the service achievement level is represented by an integer from 0 to 100. When the calculated value on the right side of Expression 3 is a negative value, the service achievement level is set to 0. When the calculated value on the right side of Expression 3 exceeds 100, the service achievement level is set to 100.

Service achievement level=100−(average waiting time before boarding(minute unit)−standard waiting time)*100/60 Expression 3

The notificator 250 displays the achievement score of each service in the achievement level window 262 of the display 260. In the example shown in FIG. 5, the achievement score of the regular route bus service is 20 points out of 100 points. Although the prediction time is shown as xx minutes later, the predicted time is a rough guide. Predicted times such as 10 minutes later, 1 hour later, 2 hours later, etc. are predefined. The time closest to the prediction time used in the calculation by the prediction model among the predefined prediction times is displayed in the achievement level 262. The achievement score of the logistics service is 40 points out of 100 points. The achievement score of the ride sharing service is 60 points out of 100 points.

When an abnormality occurs in the provision status of the resource 110, the notificator 250 displays the achievement level of each service from the top in the priority order input from the priority order calculator 235. In the example shown in FIG. 5, the regular route bus service has the highest priority, the logistics service has the second highest priority, and the ride sharing service has the lowest priority.

The priority order calculator 235 calculates the priority order based on the importance level and the service achievement level of each service. The importance level of each service is set to, for example, three levels from category 1 to category 3. The category 3 is the most important category, and the service of category 3 is a service related to human life. Examples of the services of category 3 of which the resource 110 is a road include an emergency vehicle service such an ambulance and fire engine, and a disaster logistics service for food supply in the event of a disaster. The service of category 2, which is the second most important category after category 3, is a service for maintaining city life. Examples of the services of category 2 of which the resource 110 is a road include a regular route bus service and a normal logistics service. Services other than services related to human life and services for maintaining city life are services of category 1 of which the importance level is low. For example, a ride sharing service belongs to category 1.

The priority order calculator 235 arranges priority scores calculated by the following Equation 4 in descending order as the priority order. The importance coefficient in Expression 4 is set to a larger value for a category having a higher importance level. For example, the importance coefficient of category 3 is 50, the importance coefficient of category 2 is 20, and the importance coefficient of category 1 is 1.

Priority score=(average service achievement level in past one week-current service achievement level)*importance coefficient*number of users of service expected in future one hour Expression 4

Next, the resource provision status window 264 will be described. When all services provided in the city 100 are favorable, that is, when there is no abnormality in the provision status of the resource 110, only the city map of the city 100 is displayed in the resource provision status window 264. However, when an abnormality occurs in the provision status of the resource 110, the resource provision status window 264 displays the content of the abnormality in the provision status of the resource 110.

In the example shown in FIG. 5, an area 101 where an accident has occurred is displayed on the city map of the resource provision status window 264. In the achievement level window 262, the achievement levels of the respective services are displayed in the order of the regular route bus service, the logistics service, and the ride sharing service. The accident can be grasped by cameras installed in the city 100. The accident-occurred area 101 is an intersection between the F block, the G block, the J block, and the K block and overlaps with the service target route 153 of the route buses 152A and 152B.

The screen on the display 260 as shown in FIG. 5 may allow the city manager 140 to recognize how the accident occurring in area 101 will affect the performance of each service in the immediate future. In addition, the screen on the display 260 may allow the city manager 140 to recognize that the priority order of preferentially providing the road which is the resource 110 in this situation is the order of the regular route bus service, the logistics service, and the ride sharing service.

Further, in the resource provision status window 264, a coping method for reducing the influence of the accident occurring in the area 101 with respect to the highest priority service is displayed. In the example shown in FIG. 5, the highest priority service is the regular route bus service. In the service definition of the regular route bus service, as an alternative provision method when the provision status of the resource 110 is deteriorated, detour, suspension of service, alternative transportation, walking, and the like are defined. The coping method suggester 240 selects an alternative provision method capable of minimizing the influence of the accident occurring in the area 101 on the regular route bus service from the service definition and inputs the alternative provision method to the notificator 250.

In the example shown in FIG. 5, a bypass route 153a that bypasses the area 101 where the accident has occurred is displayed in the resources provision status window 264. By selecting the suggested bypass route 153a, it is possible to stop the route buses 152A and 152B at all the bus stops 151A, 151E, 151K, 151H, and 151C without passing through the area 101 where the accidents has occurred. The city manager 140 having received the suggestion notifies the service provider of the regular route bus service of the influence of the accident occurring in the area 101 on the regular route bus service. Then, as a coping method for the accidents occurring in the area 101, the city manager 140 advises that the route buses 152A and 152B are detoured to the bypass route 153a.

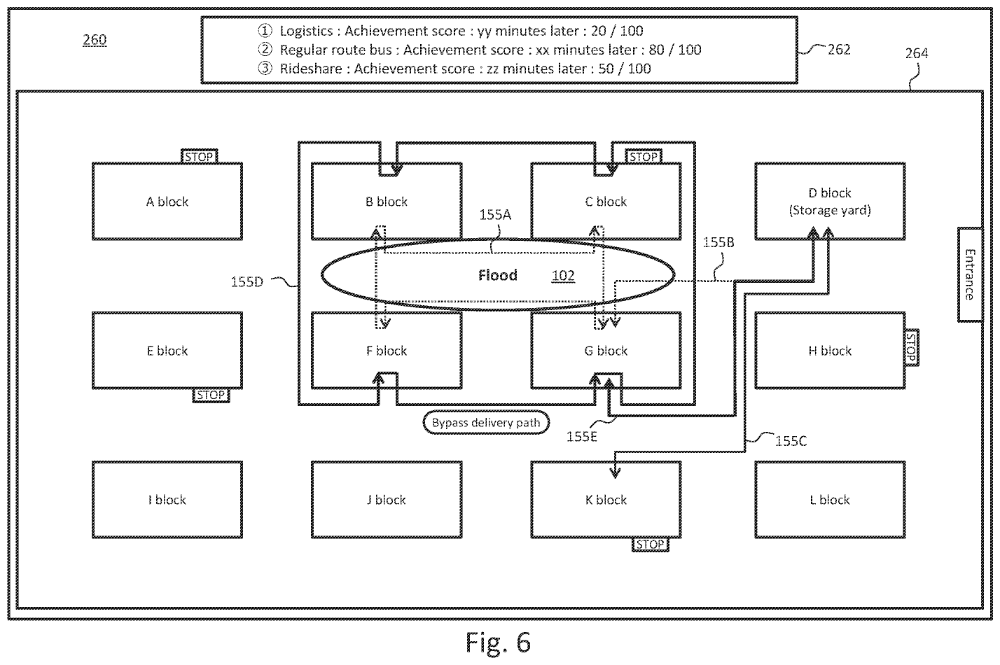

FIG. 6 shows another example of the screen of the display 260 according to the first specific example. In the example shown in FIG. 6, on the city map of the resource provision status window 264, a flooded area 102 is displayed. In the achievement level window 262, the achievement levels of the respective services are displayed in the order of the logistics service, the regular route bus service, and the ride sharing service. Flooding can be grasped by cameras installed in the city 100 and the amount of precipitation. Flooding is an abnormality in which a road as the resource 110 cannot be used, and causes a decrease in the achievement score of each service. The area 102 where flooding occurs is a road from between the B block and the F block to between the C block and the G block, and overlaps with the delivery route 154A by the delivery robot 155A. It also overlaps with the delivery route 155B by the delivery robot 154B.

The screen on the display 260 as shown in FIG. 6 may allow the city manager 140 to recognize how the flooding of the area 102 will affect the performance of each service in the immediate future. In addition, the screen on the display 260 may allow the city manager 140 to recognize that the priority order of preferentially providing the road which is the resource 110 in this situation is the order of the logistics service, the regular route bus service, and the ride sharing service. Although the current service achievement level of the ride sharing service is lower than that of the regular route bus service, the priority of the ride sharing service is lower than that of the regular route bus service because of a difference in the category.

Further, in the resource provision status window 264, a coping method for reducing the influence of the flooding occurring in the area 102 with respect to the highest priority service is displayed. In the example shown in FIG. 6, the highest priority service is the logistics service. The coping method suggester 240 selects an alternative method capable of minimizing the influence of road flooding on the logistics service from the predetermined service definition of the logistics service, and inputs the alternative provision method to the notificator 250.

In the example shown in FIG. 6, a bypass delivery route 155D that can go around the B block, the C block, the G block, and the F block by bypassing the flooded area 102 is displayed in the resources provision status window 264. In addition, a bypass delivery route 155E capable of delivering packages from the storage yard to the G block by bypassing the flooded area 102 is displayed in the resources provision status window 264. By selecting these suggested alternative delivery routes 155D and 155E, the packages can be delivered to the scheduled delivery destinations without passing through the flooded area 102. The city manager 140 having received the suggestion notifies the service provider of the logistics service of the influence of flooding of the area 102 on the logistics service. Then, the city manager 140 advises the service provider, as a copying method for the flooding of the area 102, to cause the delivery robots 154A and 154B to perform delivery using the bypass delivery routes 155D and 155E.

It should be noted that the abnormality in the road as the resource 110 is not limited to the exemplified accident and flooding. For example, road closures due to natural disasters such as earthquakes or floods, vehicle traffic closures due to snow, accumulation of fallen leaves or dead leaves, road obstacles such as on-street parking vehicles, and the like are abnormalities of the road as the resource 110. These abnormalities can be detected by sensors installed in the city 100, such as cameras.

### 3-3. Second Specific Example

### 3-3-1. Overview of Service

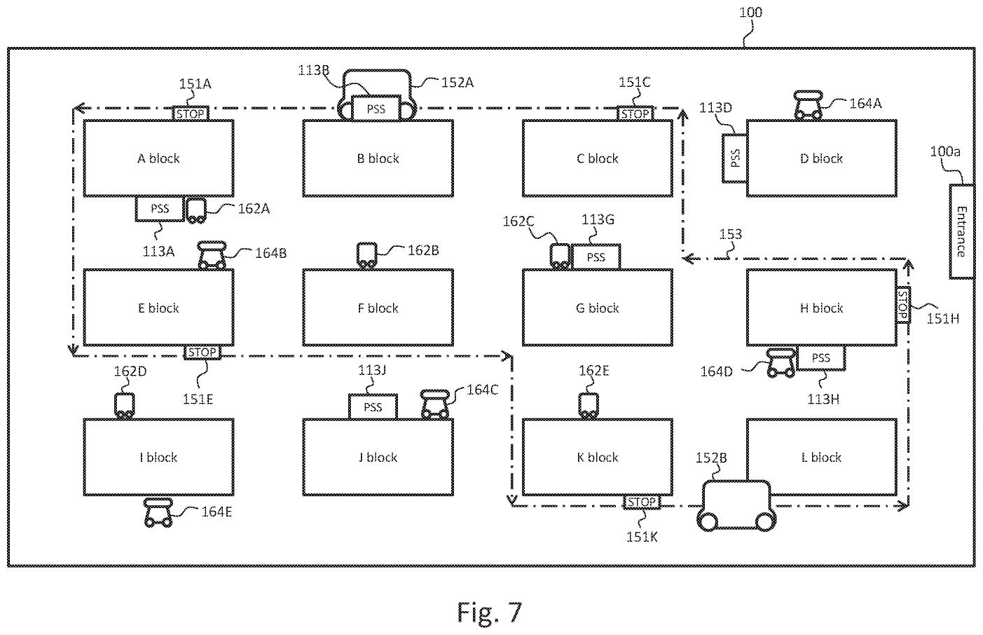

As the second specific example, an example in which the service provided in the city 100 is a service sharing power supply stations will be described. FIG. 7 is a diagram for explaining the second specific example.

In the second specific example, the resource 110 shared among services is power supply stations. In the power supply station, electric power is wirelessly supplied to various moving bodies (vehicles, robots, and the like) that are autonomously driven. Electric moving bodies (vehicles, robots, and the like) need to be charged in accordance with a battery remaining power. These moving bodies move to the power supply station by autonomous driving and charge their own batteries by wireless charging. A plurality of power supply stations 113A, 113B, 113D, 113G, 113H, and 113J are installed in the city 100.

In the second specific example, the services sharing the power supply stations that are the resource 110 are three services of regular route bus service, support robot service, and security robot service. In the example shown in FIGS. 1 and 2, the regular route bus service is the service A, the support robot service is the service B, and the security robot service is the service C. The power supply station is a finite resource 110 with a limited number of units, and is shared by mobile units of each service that require charging.

The regular route bus service is a kind of traffic service that uses the route buses 152A and 152B to carry users, and the details thereof are as described in the first specific example. A power supply station 113B is installed on a service target route 153 where the route buses 152A and 152B are operated. The route buses 152A and 152B are charged at the power supply station 113B at a predetermined timing.

The support robot service is a service of transporting personal baggage with a weight ranging from a handbag to a suitcase by using the support robots 162A to 162E. The support robot service provider 120B is, for example, a porter service corporation. The user 130 of the support robot service is a resident who moves on foot or by low-speed mobility in the city 100. The users deposit baggage on the support robots 162A to 162E, and the support robots 162A to 162E on which the baggage is deposited move following the users. The support robots 162A to 162E circulate in the city 100 or stand by at a predetermined standby place. When users want to request transportation of baggage, they make a reservation via applications of their own terminals, or find an available support robot 162A to 162E and request transportation of the baggage on the spot. The support robots 162A to 162E are electrically driven, and when the remaining battery power falls below a threshold value, they automatically go to the nearest power supply station.

The security robot service is a service in which information collection is performed by security robots 164A to 164E equipped with cameras and subsequent behavior determination is performed based on the collected information. The security robot service provider 120C is, for example, a security company. The user 130 of the security robot service is not only an individual living in the city 100 but also a corporation or an organization such as a company, a shop, or a shopping center. The security robots 164A to 164E are equipped with various sensors including cameras, and patrol the set route at set times. In addition, when there is an instruction from a monitoring center of a security company, or when users make a request via applications of their own terminals, the security robots 164A to 164E deviate from the set route and go to the instructed or requested spot for monitoring. The security robots 164A to 164E are electrically driven, and automatically go to a predetermined power supply station at a predetermined timing for charging.

### 3-3-2. Example of Screen of City Management Support Apparatus

If the three services described above are provided in the city 100, the city management support apparatus 200 provides support information on those services to the city manager 140.

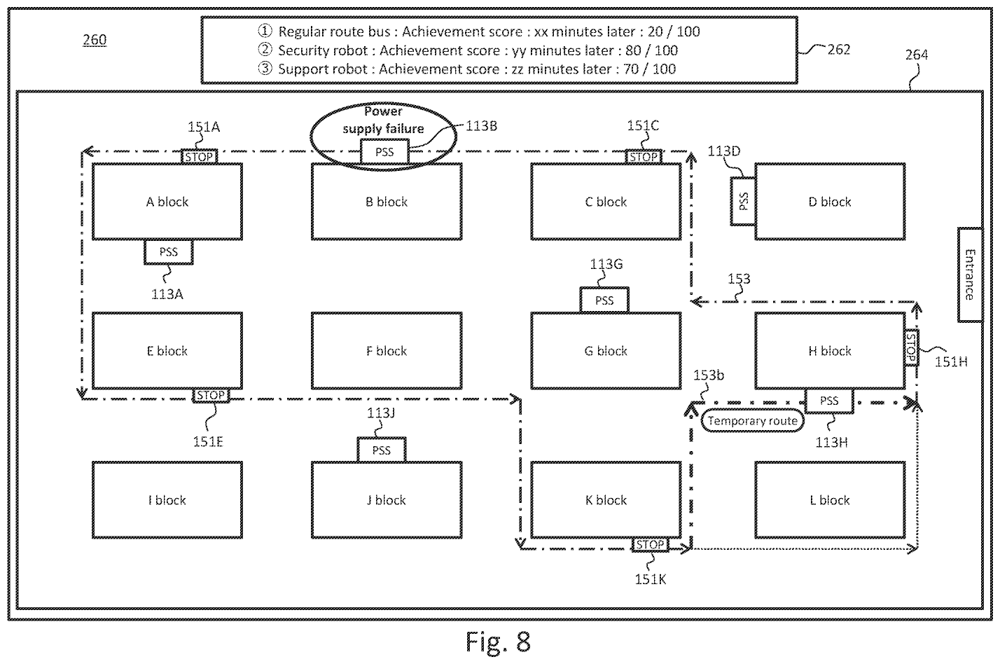

FIG. 8 shows an example of a screen of the display 260 of the city management support apparatus 200 in the second specific example. In the achievement level window 262, the service achievement level after a predetermined time for each service of regular route bus, support robot, and security robot is displayed as a score (achievement score). Hereinafter, a method of calculating the degree of achievement for each service will be described. However, since the method of calculating the service achievement level of the regular route bus service is the same as that described in the first specific example, repeated description will be omitted here.

A method of calculating the service achievement level of the support robot service by the city management support apparatus 200 will be described. The information on the provision status of the support robot service input to the service simulator 220 of the city management support apparatus 200 includes, for example, information on the state of each support robot and the number of remaining unhandled requests. The information on the state of the support robot includes, for example, a position, a speed, the number of loads, whether or not the support robot is in service, a remaining battery power, a delivery destination, and a delivery source. These pieces of information are input to the service simulator 220. The service simulator 220 predicts the number of unhandled requests after a predetermined time based on the input information. Then, the predicted number of unhandled requests is output as a status prediction value of the support robot service.

The achievement level calculator 230 calculates a service achievement level based on the number of unhandled requests predicted by the service simulator 220. The following Equation 5 is used to calculate the service achievement level of the support robot service. The standard number of requests in Expression 5 is a numerical value determined from the standard SLA, and can be set to 5, for example. The coefficient is a numerical value that can be arbitrarily set, and can be set to 5, for example. As the value of the coefficient increases, the influence of the number of unhandled requests on the service achievement level increases. However, the calculated value on the right side of Expression 5 is rounded off to be an integer, and the service achievement level is represented by an integer from 0 to 100. When the calculated value of the right side of Expression 5 is a negative value, the service achievement level is set to 0. When the calculated value on the right side of Expression 5 exceeds 100, the service achievement level is set to 100.

Service achievement level=100−(number of unhandled request−number of robots in service*number of standard requests)*coefficient Equation 5

Next, a method of calculating the service achievement level of the security robot service by the city management support apparatus 200 will be described. The information on the provision status of the security robot service input to the service simulator 220 of the city management support apparatus 200 includes, for example, information on the state of each security robot and a scheduled route. The information on the state of the security robot includes, for example, a location, a speed, whether the security robot is in service, and a remaining battery power. These pieces of information are input to the service simulator 220. The service simulator 220 predicts a monitoring range (square meter) in units of time based on the input information. Then, the predicted monitoring range is output as the status prediction value of the security robot service.

The achievement level calculator 230 calculates the service achievement level based on the monitoring range predicted by the service simulator 220. The following Expression 6 is used to calculate the service achievement level of the security robot service. The coefficient in Expression 6 is a numerical value that can be arbitrarily set, and can be set to 10, for example. As the value of the coefficient is smaller, the influence of the reduction of the monitoring range on the service achievement level becomes larger. However, the calculated value on the right side of Expression 6 is rounded off to be an integer, and the service achievement level is represented by an integer from 0 to 100. When the calculated value on the right side of Expression 6 is a negative value, the service achievement level is set to 0.

Service achievement level=100−(planned monitoring range(square meter)−predicted monitoring range)/coefficient Expression 6

The notificator 250 displays the achievement score of each service in the achievement level window 262 of the display 260. In the example shown in FIG. 8, the achievement score of the regular route bus service is 20 points out of 100 points. The achievement score of the support robot service is 70 points out of 100 points. The achievement score of the security robot service is 80 points out of 100 points. Note that the support robot service and the security robot service belong to the same category in importance level. Although the current service achievement level of the support robot service is lower than that of the security robot service, the priority of the support robot service is lower than that of the security robot service because of a difference in the average service achievement level in the past one week or a difference in the number of service users expected in the next one hour.

Next, the display of the resource provision status window 264 in the second specific example will be described. In the example shown in FIG. 8, the power supply station 113B that cannot supply power is displayed on the city map of the resources provision status window 264. In the achievement level window 262, the achievement levels of the respective services are displayed in the order of the regular route bus service, the security robot service, and the support robot service. The power supply failure of the power supply station is an abnormality caused by disconnection of an electric wire for supplying power to the power supply station or a failure of the power supply station itself. The abnormality in the power supply station can be grasped from, for example, a charging state of the moving body during power supply. The power supply station 113B that cannot supply power is on the service target route 153 of the route buses 152A and 152B, and is used for charging the route buses 152A and 152B.

The screen on the display 260 as shown in FIG. 8 may allow the city manager 140 to recognize that the achievement level of the regular route bus service will decrease in the near future due to the power supply failure in the power supply station 113B. In addition, the screen on the display 260 may allow the city manager 140 to recognize that the priority order of preferentially providing the power supply station which is the resource 110 in this situation is the order of the regular route bus service, the security robot service, and the support robot service.

Further, in the resource provision status window 264, a coping method for reducing the influence of the abnormality in the power supply station 113B with respect to the highest priority service is displayed. In the example shown in FIG. 8, the highest priority service is the regular route bus service. The coping method suggester 240 selects an alternative provision method capable of minimizing the influence of the accident in the power supply station 113B on the regular route bus service from the service definition and inputs the alternative provision method to the notificator 250.

In the example shown in FIG. 8, a temporary route 153b passing through a power supply station 113H is displayed in the resources provision status window 264. If the suggested temporary route 153b is selected, it is possible to stop the route buses 152A and 152B at all the bus stops 151A, 151E, 151K, 151H, and 151C while enabling charging at the power supply station 113H. The city manager 140 having received the suggestion notifies the service provider of the regular route bus service of the influence of the power supply failure in the power supply station 113B on the regular route bus service. Then, the city manager 140 advises the service provider, as a coping method for the abnormality in the power supply station 113B, to use the power supply station 113H by switching the route of the route buses 152A and 152B to the temporary route 153b.

### 3-4. Third Specific Example

### 3-4-1. Overview of Service

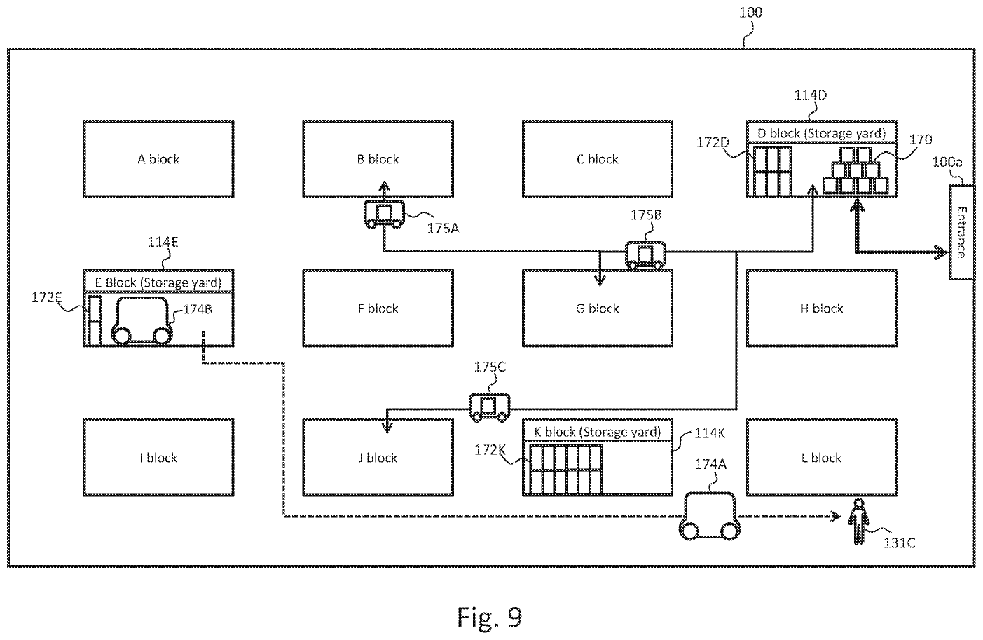

As the third specific example, an example in which the service provided in the city 100 is a service sharing storage yards will be described. FIG. 9 is a diagram for explaining the third specific example.

In the third embodiment, the resource 110 shared among services is storage yards. Since the storage yard is an area having a certain space, the storage yard can be used as a storage place for temporarily placing materials and can also be used as a parking place for temporarily placing vehicles. The city 100 is provided with a plurality of storage yards 114D, 114E and 114K.

In the third specific example, the services sharing the storage yards that are the resource 110 are three services of logistics service, rental trunk room service for residents of the city 100, and on-demand bus service. In the example shown in FIGS. 1 and 2, the logistics service is the service A, the rental trunk room service is the service B, and the on-demand bus service is the service C. The storage yard is a finite resource 110 with limited available area and is shared by services that require space for temporary placement of materials and vehicles.

The logistics service is a service of delivering a package between bases or between buildings using a delivery robot, and the details thereof are as described in the first specific example. The packages transported to the city 100 from the outside are carried into the city 100 from the entrance 100a, and are collected in the storage yard 114D provided in the D block closest to the entrance 100a. The packages 170 collected in the storage yard 114D are delivered to various places (including a relay station of packages) in the city 100 by the delivery robots 175A, 175B, and 175C.

The rental trunk room service is a service for renting movable trunks 172D, 172E, and 172K as storerooms. The provider 120B of the rental trunk room service is, for example, a warehouse corporation. The user 130 of the rental trunk room service is a resident of the city 100. The trunks 172D, 172E, and 172K are installed at corners of the storage yards 114D, 114E, and 114K in the city 100. Since the trunks 172D, 172E, and 172K are containers that can be transferred by truck, the installation locations and the number of installations are changed in accordance with the use frequency of the service and the use state of the service. For example, it is possible to increase the number of the trunks 114E to be installed in the storage yard 172E of the E block according to the request of the residents of the A block, or conversely, to move the trunk to the storage yard 114D of the D block far from the A block and reduce the usage fee instead.

The on-demand bus service is a service for allocating on-demand buses 174A and 174B in response to an allocation request from a passenger. The provider 120C of the on-demand bus service is, for example, a bus company. The user 130 of the on-demand bus service is a passenger traveling on the on-demand bus. For the on-demand buses 174A and 174B, electrically driven self-driving buses equipped with rechargeable batteries are used. A passenger 131C who wants to use the on-demand bus service specifies pick-up/drop-off locations and time via an application of his/her own terminal. In response to a vehicle allocation request from the passenger 131C, the on-demand bus 174A, which is waiting, is allocated to a designated location at a designated time. The storage yard 111E is used as a parking place in which the on-demand buses 174A and 174B are kept waiting.

### 3-4-2. Example of Screen of City Management Support Apparatus

If the three services described above are provided in the city 100, the city management support apparatus 200 provides support information on those services to the city manager 140.

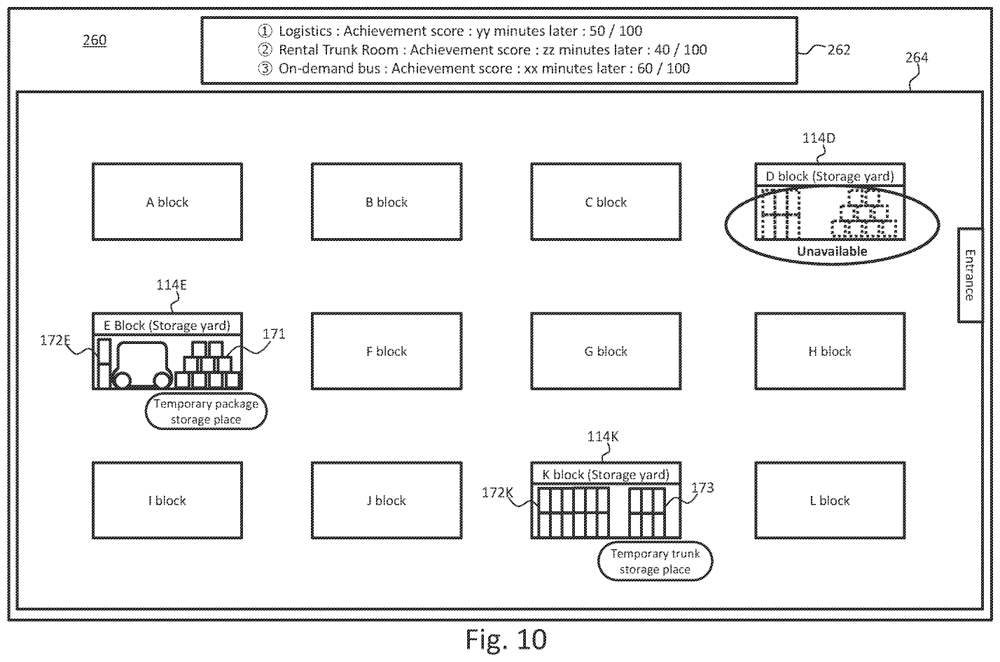

FIG. 10 shows an example of a screen of the display 260 of the city management support apparatus 200 in the third specific example. In the achievement level window 262, the service achievement level after a predetermined time for each of the logistics service, the rental trunk room service, and the on-demand bus is displayed as a score (achievement score). Hereinafter, a method of calculating the degree of achievement for each service will be described. However, since the method of calculating the service achievement level of the logistics service is the same as that described in the first specific example, repeated description will be omitted here.

A method of calculating the service achievement level of the rental trunk room service by the city management support apparatus 200 will be described. The information on the provision status of the rental trunk-room service input to the service simulator 220 of the city management support apparatus 200 includes, for example, information on the state of each trunk and a movement schedule. The information on the state of the trunk includes, for example, an installation place, a contractor, and a load capacity. These pieces of information are input to the service simulator 220. The service simulator 220 predicts an average distance (meter unit) between the trunk and the residence of each contractor assumed to use the trunk within a predetermined time based on the input information. Then, the predicted average distance is output as a status prediction value of the rental trunk room service.

The achievement level calculator 230 calculates the service achievement level based on the average distance predicted by the service simulator 220. The following Equation 7 is used to calculate the service achievement level of the rental trunk room service. The standard distance in Expression 7 is an average distance allowed by the user, and can be set to 300 meters, for example. The coefficient is a numerical value that can be arbitrarily set, and can be set to 10, for example. The smaller the value of the coefficient is, the greater the effect of increasing the average distance on the service achievement level is. However, the calculated value on the right side of Expression 7 is rounded off to be an integer, and the service achievement level is represented by an integer from 0 to 100. When the calculated value on the right side of Expression 7 is a negative value, the service achievement level is set to 0.

Service achievement level=100−(predicted average distance−standard distance)/coefficient Expression 7

Next, a method of calculating the service achievement level of the on-demand bus service by the city management support apparatus 200 will be described. The information on the provision status of the on-demand bus service input to the service simulator 220 of the city management support apparatus 200 includes, for example, information on the state of each vehicle and information on demand. The information on the state of the vehicle includes, for example, a location, a speed, the number of passengers, whether the vehicle is in service, and a remaining battery power. The information on demand includes, for example, time, start and end points, and the number of people. These pieces of information are input to the service simulator 220. The service simulator 220 predicts an average delay time (for example, an average value in the past one hour) from the designated time based on the input information. Then, the predicted average delay time is output as a status prediction value of the on-demand bus service.

The achievement level calculator 230 calculates the service achievement level based on the average delay time predicted by the service simulator 220. The following Equation 8 is used to calculate the service achievement level of the on-demand bus service. The coefficient in Expression 8 is a numerical value that can be arbitrarily set, and can be set to 30 seconds, for example. The smaller the value of the coefficient, the greater the influence of the delay on the service achievement level. However, the calculated value on the right side of Expression 8 is rounded off to be an integer, and the service achievement level is represented by an integer from 0 to 100. When the calculated value on the right side of Expression 8 is a negative value, the service achievement level is set to 0.

Service achievement level=100−average delay time/coefficient Expression 8

The notificator 250 displays the achievement score of each service in the achievement level window 262 of the display 260. In the example shown in FIG. 10, the achievement score of the logistics service is 50 points out of 100 points. The achievement score of the rental trunk room service is 40 points out of 100 points. The achievement score of the on-demand bus service is 60 points out of 100 points.

The service achievement level of the on-demand bus service calculated by Expression 8 is a service achievement level (first value) from the viewpoint of the service provider of the on-demand bus service. From the viewpoint of a user of the on-demand bus service, a service achievement level (second value) calculated by the following Expression 9 may be used. Alternatively, both of the service achievement level calculated by Expression 9 and the service achievement level calculated by Expression 8 may be used. When Equation 9 is used, the service simulator 220 predicts the number of passengers after a predetermined time. The coefficient in Expression 9 is a numerical value that can be arbitrarily set, and can be set to 10, for example. As the value of the coefficient increases, the influence of the degree of congestion (the ratio of the number of passengers with respect to the number of seats) on the service achievement level increases. However, the calculated value on the right side of Equation 9 is rounded off to be an integer, and the service achievement level is represented by an integer from 0 to 100. When the calculated value on the right side of Expression 9 is a negative value, the service achievement level is set to 0.

Service achievement level=100−coefficient*number of passengers/number of seats Expression 9

Next, the display of the resource provision status window 264 in the third specific example will be described. In the example shown in FIG. 10, the storage yard 114D that is unavailable is displayed on the city map of the resources provision status window 264. In the achievement level window 262, the achievement levels of the respective services are displayed in the order of the logistics service, the rental trunk service, and the on-demand bus service. The unavailability of the storage yard is an abnormality in which a part of the space of the storage yard becomes unavailable due to, for example, collapse of packages. The abnormality in the storage yard can be grasped from an image of a camera installed in the storage yard, for example. The storage yard 114D that is unavailable is used as a storage place for the packages 170 and is also used as a storage place for the trunk 172D.

The screen on the display 260 as shown in FIG. 10 may allow the city manager 140 to recognize that the achievement levels of the logistics service and the rental trunk room service will decrease in the near future due to the unavailability of the storage yard 114D. In addition, the screen on the display 260 may allow the city manager 140 to recognize that the priority order of preferentially providing the storage yard which is the resource 110 in this situation is the order of the logistics service, the rental trunk service, and the on-demand bus service. Although the current service achievement level of the rental trunk service is lower than that of the logistics service, the priority of the rental trunk service is lower than that of the logistics service because of a difference in category. The logistics service is classified in category 2, whereas rental trunk service is classified in category 1.

Further, in the resources provision status window 264, a coping method for reducing the influence of the unavailability of the storage yard 114D is displayed for each of the highest priority service and the second highest priority service. In the example shown in FIG. 10, the highest priority service is the logistics service, and the second highest priority service is the rental trunk service. The coping method suggester 240 selects an alternative provision method capable of minimizing the influence of the unavailability of the storage yard 114D on the logistics service and the rental trunk service from the service definition and inputs the alternative provision method to the notificator 250.

In the example shown in FIG. 10, a temporary storage place (temporary package storage place) for packages 171 provided in the storage yard 114E is displayed in the resources provision status window 264. By using the suggested temporary package storage place as a storage place for the packages 171, it is possible to deliver packages from the temporary package storage place to each place (including a relay place for packages) in the city 100, and it is possible to suppress confusion of the logistics in the city 100. The city manager 140 having received the suggestion notifies the service provider of the logistics service of the influence of the unavailability of the storage yard 114D on the logistics service. Then, the city manager 140 advises the service provider, as a coping method for the unavailability of the storage yard 114D, to use the storage yard 114E as a temporary package storage place.

However, the storage yard 114E is used as a parking place of two on-demand buses 174A and 174B. If the service provider of the logistics service secures a temporary package storage place widely in the storage yard 114E, even one on-demand bus 174A or 174B cannot be parked there. Therefore, in the resources provision status window 264, the use limit of the storage yard 114E as a temporary package storage place is displayed. The city manager 140 requests cooperation from the service provider of the logistics service based on the use limit of the storage yard 114E as the resources 110 displayed in the resources provision status window 264.

The on-demand bus that can be parked in the storage yard 114E is limited to any one of the on-demand buses 174A and 174B by using the storage yard 114E as a temporary package storage place. However, the on-demand buses 174A and 174B can drive automatically, and there are other places in the city 100 where parking is possible. Therefore, when considering the effective use of the storage yard 114E as the finite resources 110 of the city 100, using the storage yard 114E as the temporary package storage place improve the overall service achievement level more. The city manager 140 notifies the service provider of the on-demand bus service that a part of the parking place of the storage yard 114E is to be used as a temporary package storage place. At this time, some incentive may be given from the city manager 140 to the service provider of the on-demand bus service in return for evacuating the parking place.

Further, in the example shown in FIG. 10, a temporary storage place (temporary trunk storage place) for the trunk 173 provided in the storage yard 114K is displayed in the resources provision status window 264. By using the suggested temporary trunk storage place as a storage place for the trunk 173, inconvenience of residents who use the rental trunk room service can be reduced. The city manager 140 having received the suggestion notifies the service provider of the rental trunk room service of the influence of the unavailability of the storage yard 114D on the rental trunk room service. Then, the city manager 140 advises the service provider, as a coping method for the unavailability of the storage yard 114D, to use the storage yard 114K as a temporary trunk storage place.

### 4. Others

The network may also be referred to as a finite resource 110 of the city 100. Examples of the services sharing a network include a remote driving service for a remote driving vehicle and a moving image distribution service. The abnormality in the provision state of the network as the resource 110 is, for example, that the bandwidth becomes tight due to congestion of the network. When the bandwidth of the network becomes tight, remote driving using mobile communication cannot be continued, and switching from remote driving to automatic driving tends to occur. Therefore, a remote driving rate can be used as the service achievement level of the remote driving service. As the service achievement level of the moving image distribution service, a freeze rate of a moving image within a certain period of time can be used. Note that the remote driving service is a service that belongs to category 3 because it is related to human life. On the other hand, the moving image distribution service belongs to category 1. Therefore, for example, in a case where the bandwidth is tight, the remote driving service is relatively likely to be prioritized.

Electric power may also be a finite resource 110 of the city 100. Services sharing electric power include a hospital cooling and heating management service and an personal cooling and heating management service. The hospital cooling and heating management service is a service that belongs to category 3 because it is related to human life. On the other hand, the personal cooling and heating management service belongs to category 2 because it is a service for maintaining urban life. Therefore, for example, in a case where the electricity supply is tight, the hospital cooling and heating management service is relatively likely to be prioritized.

What is claimed is:

1. A city management support apparatus for supporting management of a city in which a plurality of services sharing a finite resource are simultaneously provided, the city management support apparatus comprising:
at least one memory storing at least one program; and
at least one processor configured to execute the at least one program,
wherein the at least one program is configured to cause the at least one processor to execute:
acquiring information on a provision status of the resource;
predicting a service achievement level of each of the plurality of services in future by a predetermined time based on the provision status of the resource;
calculating priority order of provision of the resource among the plurality of services based on a service content and the service achievement level of each of the plurality of services; and
outputting the priority order among the plurality of services.

2. The city management support apparatus according to claim 1,
wherein the at least one program is configured to cause the at least one processor to execute outputting the priority order among the plurality of services in a form associated with the provision status of the resource.

3. The city management support apparatus according to claim 2,
wherein the at least one program is configured to cause the at least one processor to execute outputting the priority order among the plurality of services in a form associated with the provision status of the resource together with the service achievement level for each of the plurality of services.

4. The city management support apparatus according to claim 1,
wherein the at least one program is configured to cause the at least one processor to execute predicting the service achievement level of each of the plurality of services in response to occurrence of an abnormality in the provision status of the resource.

5. The city management support apparatus according to claim 4,
wherein the at least one program is configured to cause the at least one processor to execute:
calculating a use limit of the resource for each of the plurality of services based on the service content and the service achievement level of each of the plurality of services; and
outputting the use limit for each of the plurality of services.

6. A city management support method for supporting, using a computer, management of a city in which a plurality of services sharing a finite resource are simultaneously provided, the city management support method comprising:
inputting information on a provision status of the resource to the computer;
predicting, by the computer, a service achievement level of each of the plurality of services in future by a predetermined time based on the provision status of the resource;
calculating, by the computer, priority order of provision of the resource among the plurality of services based on a service content and the service achievement level of each of the plurality of services; and
outputting the priority order among the plurality of services from the computer.

7. A non-transitory computer-readable storage medium storing a city management support program for causing a computer to execute processing for supporting management of a city in which a plurality of services sharing a finite resource are simultaneously provided, the processing comprising:
acquiring information on a provision status of the resource;
predicting a service achievement level of each of the plurality of services in future by a predetermined time based on the provision status of the resource;
calculating priority order of provision of the resource among the plurality of services based on a service content and the service achievement level of each of the plurality of services; and
outputting the priority order among the plurality of services.
